(19) United States
(12) Patent Application Publication
(10) Pub. No.: US 2024/0157273 A1
(43) Pub. Date: May 16, 2024

(54) DIRECT THORIUM TO RADIUM GENERATOR

(71) Applicant: UCHICAGO ARGONNE, LLC, Chicago, IL (US)

(72) Inventor: Michael Alexander Brown, Chicago, IL (US)

(73) Assignee: UCHICAGO ARGONNE, LLC, Chicago, IL (US)

(21) Appl. No.: 17/987,680

(22) Filed: Nov. 15, 2022

(51) Int. Cl. B01D 15/36; B01D 15/22; B01D 15/42; C01F 13/00; G21G 7/00

(52) U.S. Cl. CPC B01D 15/361; B01D 15/22; B01D 15/426; C01F 13/00; G21G 7/00

(57) ABSTRACT

The invention provides a method for generating a daughter isotope, the method comprising contacting an ion exchange column with parent isotope; allowing the column to equilibrate between the parent and daughter isotopes; eluting the daughter isotope from the column; and repeating the equilibration and elution steps. Also provided is a system for repeatedly generating isotopes from the same support column over time with a single loading of parent isotope, the system comprising a radiation-resistant sorbent column; a parent isotope permanently contained within the column; and a fluid to elute daughter isotope from the column.

### CONTRACTUAL ORIGIN OF THE INVENTION

The U.S. Government has rights in this invention pursuant to Contract No. DE-AC02-06CH11357 between the U.S. Department of Energy and UChicago Argonne, LLC, representing Argonne National Laboratory.

### BACKGROUND OF THE INVENTION

### 1. Field of the Invention

This invention relates to the production of isotopes and more specifically, this invention relates to a system and method for direct generation of daughter isotopes.

### 2. Background of the Invention

The rapid production and distribution of radioisotopes to medical facilities through a direct generator platform is the “holy grail” of large-scale medical isotope technologies. Isotope generators are the fastest and most efficient method for delivering select isotopes to hospitals.

Four isotopes of thorium (²²⁷Th, ²²⁸Th, ²²⁹Th, and ²³²Th) breed valuable isotopes of radium (²²³Ra, ²²⁴Ra, ²²⁵Ra, and ²²⁸Ra) that have found widespread applications in radiopharmaceuticals for metastasized cancers or other industrial uses. The 2018 alpha emitter market for the treatment of various cancers was over $500M and expected to grow to over $3B by 2024.

Analogous to a female cow that can be periodically ‘milked’, the isotopes ^{227-229,232}Th produce useable quantities of radium isotopes within a matter of days to weeks to months, depending on the pair. The lifetime of this technology depends on the half-life but could theoretically last for decades in the case of ²²⁹Th. Ideally, if the thorium can be captured on a stationary column and periodically ‘milked’ for radium (and without disturbing the retained thorium), then the product becomes more prolific, and accessible. Therefore, clinical trials can be accelerated in the presence of such an abundant resource.

A common paradigm in isotope generation technology is the use of “inverse generators.” As depicted in FIG. 1, inverse generators feature sorbents that facilitate the cyclic adsorption and elution of parent isotope, such that the parent isotope is not permanently stationary on the sorbent column. For example, a parent isotope/daughter isotope mixture is fully processed whenever a query for daughter isotope occurs. After the daughter isotope is generated, the parent isotope is then removed from any column or other supports and kept dormant until the next query. Upon a removal, the stock is usually maintained in a radiation-resistant bottle or vial as a liquid or dried salt. As such, these machinations require extra effort by trained personnel, and therefore entails additional costs.

Also, since the parent isotope cannot be fixed onto a resilient support, this usually prevents mobility. Thus the product must be purified in a fixed location at all times, that location comprising specialized personnel and subjected to regulations related to radiation handling and storage.

Platforms such as organic anion exchange or extraction chromatographic resins are commonly used to separate thorium from radium. Conventional organic resins include cation-exchange (Dowex 50, Amberlight, KU2), anion-exchange (AG-MP, Dowex 1,2, strongly basic), or extraction chromatography (Eichrom, Triskem). These supports are commonly used in tandem with strong acids such as nitric or hydrochloric acids. (In the context presented here, strong acid is defined as any liquid with a pH less than 0 or an acid concentration greater than 1M.)

Over long periods of time, the presence of strong acids can promote technical challenges with steel-based equipment or electronics and can be deleterious to expensive hot-cell facilities. Also, the above identified resins are susceptible to radiation damage and cannot withstand large quantities of thorium (Th), radium (Ra), actinium (Ac) or decay products. For example, as little as 3 miCi of ²²⁵Ac can clog or otherwise disrupt cation-exchange resins after radiolysis. Approximately 15 miCi ²²⁵Ac cause catastrophic failure of an AGMP-50 column. Generally 5 miCi of ²²⁶Ra can not be recovered from cation exchange resins.

As a result, inverse generators require much more processing time and material compared to “direct generators.”

Direct generators exist for medical diagnostic applications and feature sorbents wherein the parent isotope remains stationary on the column and the daughter isotopes can be removed. Today's workhorse diagnostic isotope generator is comprised of Mo99/Tc99m. But that chemistry focuses on hexavalent and heptavalent separation chemistry between Mo/Tc, respectively. Also, the mobile phase is saline which would facilitate elution of radium

Another diagnostic generator is Ge/Ga, which exploits trivalent ion chemistry. But the mobile phase is HCl which would elute more than Ra and therefore confound any attempts to generate pure radium.

However, no technology exists that can fix parent isotopes onto a radiation-resistant column from which daughter isotopes can be eluted for use in therapeutic applications. Specifically, no technology exists which exploits tetravalent parent isotope and divalent daughter isotope in the separation of the latter on inorganic resins.

Certainly, no technology exists that can fix isotopes of thorium onto a radiation-resistant column while radium can be milked. Because of the ionizing capabilities of thorium isotopes, and subsequent daughters, it is impractical to leave thorium on a stationary organic column which is susceptible to radiation damage.

Problems abound with Th/Ra isotope paradigms. Generally, these configurations embody unreliable production routes or yield questionable purities of daughter streams. Also, special nuclear materials and concomitant regulations are often involved. Challenges in chemical purifications exist, as well as challenges associated with radiation and personnel handling. Transportation is also an issue with these generally immobile and remotely-situated generators.

A need exists in the field of radiopharmaceuticals for a radiation resistant support that can retain parent isotopes over a long period of time. The same support must be able to easily release daughter isotopes (e.g. radium, lead, bismuth, polonium, astatine, radon, and thallium) without dislodging or otherwise disrupting the parent isotope immobilized on the support.

### SUMMARY OF INVENTION

An object of the invention is to provide a system and method for producing medical isotopes that overcomes many of the drawbacks of the prior art.

Another object of the invention is to provide a system and method for efficiently producing medical isotopes. A feature of the invention is the use of a radiation-resistant isotope generator. An advantage of the invention is that it delivers isotopically pure daughter isotope that can be directly incorporated into pharmaceutical kits. Another advantage is that the invented generator can be located at, easily transported, or otherwise moved to, a dispensary such as a hospital, clinic, or other venue where patients are treated. The generators may also be stored and even refreshed or otherwise reconditioned at such venues.

Still another object of the invention is to provide a robust system and method for producing medical isotopes. A feature of the invention is the use of an inorganic exchange column wherein the parent isotope can remain on the column indefinitely, such that the parent isotope is removably immobilized on the column. An advantage of the invention is that the column can operate in high radiation fields (e.g., up to 1E8 centiGray (cGy) of alpha dose) without decomposition. Also, the column can be dried out such that it need not be in constant contact with eluting fluid between milkings (i.e. harvestings) of daughter isotope from the column.

Yet another object of the present invention is to provide a system and method for direct generation of radium from thorium. A feature of the invention is the interaction of tetravalent thorium and divalent radium on inorganic resin material. An advantage of the invention is the elution of radium from the resin using acetate upon reaching predetermined thresholds while leaving the thorium stationary on the resin material.

Briefly, the invention provides a method for generating a daughter isotope, the method comprising contacting an inorganic ion exchange column with parent isotope; allowing the column to equilibrate between the parent and daughter isotopes; eluting the daughter isotope from the column without disturbing the immobilized parent isotope; and repeating the equilibration and elution steps. The parent isotope, which may be permanently or reversibly attached to the column, is selected from an element with an atomic number greater than 88 and the daughter isotope may be selected from element with an atomic number greater than 81.

Also provided is a system for repeatedly generating isotopes from the same support column over time with a single loading of parent isotope, the system comprising a radiation-resistant sorbent column; a parent isotope reversibly immobilized within the column; and a fluid to elute daughter isotope from the column.

### BRIEF DESCRIPTION OF DRAWING

The invention together with the above and other objects and advantages will be best understood from the following detailed description of the preferred embodiment of the invention shown in the accompanying drawings, wherein:

FIG. 1 depicts a prior art inverse generator;

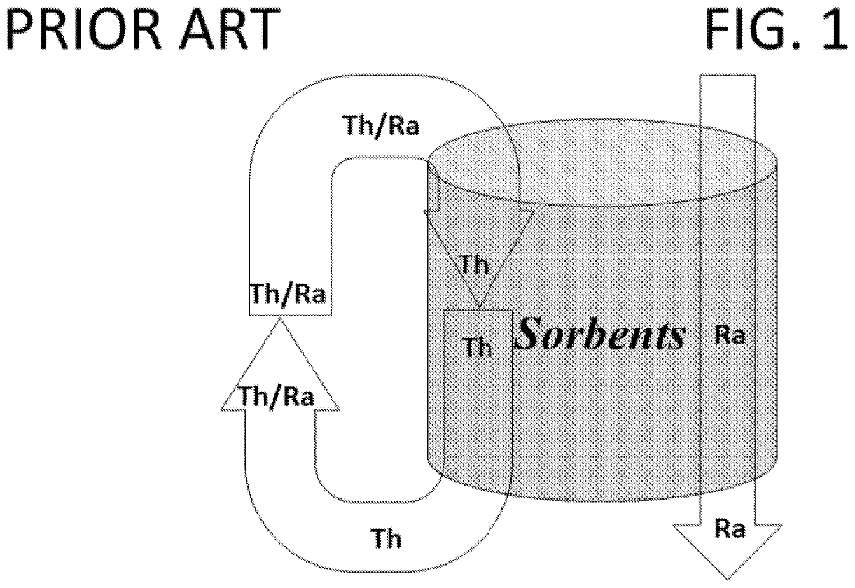

FIG. 2 is a graph of equilibrium decay of ²²⁸Th/²²⁴Ra, in accordance with features of the present invention; and

FIG. 3 is graph showing continuity of daughter isotope radioactivity over several elution cycles, in accordance with features of the present invention.

### DETAILED DESCRIPTION OF THE INVENTION

The foregoing summary, as well as the following detailed description of certain embodiments of the present invention, will be better understood when read in conjunction with the appended drawings.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. For example, while portions of this specification emphasize the generation of radium isotopes from thorium parent isotopes, other parent daughter separations are facilitated with the invention. These pairs include ²²⁷Th/²²³Ra, ²²⁸Th/²²⁴Ra, ²²⁹Th/²²⁵Ra, and ²³²Th/²²⁸Ra. Furthermore, multiple separations may be facilitated wherein the column is loaded with a plurality of parent isotopes and elutions of various daughter isotopes occur at specific times, depending on half-lives of each isotope.

Moreover, unless explicitly stated to the contrary, embodiments “comprising” or “having” an element or a plurality of elements having a particular property may include additional such elements not having that property.

The invention provides a means for leveraging secular equilibrium decay of a parent isotope to generate continual high quantity output of daughter isotopes. (Secular decay indicates a long-lived radioactive parent such as ²²⁸Th and its short-lived daughter ²²⁴Ra.) The invented system may be either stationary or mobile such that in the later instance, the generator may be located closer to the site of ultimate dispensary such as a hospital, outpatient clinic, etc.

A salient element of the invention is that the direct generator is milked (i.e., harvested) on a user specific basis. This user-defined threshold is based on the half-lives of the parent isotope/daughter isotope pair. To extend this milking metaphor for example, one either wants a short glass of milk now and wait less time for it or one wants a full gallon and is willing to wait longer for the cow to fill up.

Operators may designate a desired threshold after which harvesting or milking commences. That threshold is user-specific and customer based and depends on the isotope pair. Determining when that threshold is reached is calculated using the half-lives. A user may generate a spreadsheet comprising a database documenting the initial activities and when to milk the column. For example, if a dispensary's patient needs require a continual supply of radio-isotope, the duration of column equilibration times may be short, say 5 days. Alternatively, if a dispensary's patient needs require an intermittent but rather high dose of radioisotope, equilibration times may be selected such that a higher saturation (e.g., higher than 50 percent) of daughter isotope is attained; so equilibration times may be relatively longer, say 2-3 weeks, or even months. (Complete “saturation” means 100 percent of the possible radium maximum possible daughter isotope reactivity based on total decaying parent isotope present. Saturation level depends on the half lives of the isotopes and how long the user waits between milkings or harvestings.)

Reiterating this milking metaphor, if one wants a glass of milk immediately, she could milk the cow when it's approximately 10 percent full and get a short glass. Or she could wait until the cow is 100 percent full (saturated) and obtain a larger glass, or many glasses, of milk. Similarly, some end users of this technology may only require 5 percent saturation of daughter isotope on the resin while others may require 100 percent saturation.

Generators do not always operate at the same frequency. Fresh generators can be milked more frequently whereas aged generators might be milked less to allow ingrowth. If there is a large quantity of parent isotope, 5 percent daughter isotope activity may be sufficient. For example, if there are only 10 Thoriums on the column, 0.5 Ra might not be enough. However, if there 10 Million thoriums, 0.5 Million Ra is probably more than enough.

In an embodiment of the invention, acetate solution is utilized within a predetermined pH window to remove radium daughter isotope from an inorganic resin while keeping thorium parent isotope immobilized on the resin. None of the state of the art separation technologies (i.e., Mo/Tc, Ge/Ga) described supra so use acetate.

A myriad of supports can be utilized as the parent isotope support, including, but not limited to inorganic metal oxides selected from the group consisting of zirconia (ZrO₂), titania (TiO₂), magnesia (MnO₂), alumina (Al₂O₃), Tin (SnO₂), Niobium (Nb₂O₅), and combinations thereof. Preferable inorganic metal oxides do not include phosphates or phosphorous-based compounds, gels, carbons, or alkaline metals (e.g. sodium).

In an embodiment of the invention, thorium is loaded onto a zirconia support and radium is periodically removed. ZrO₂ may be used as the platform for these separations.

Mixtures of Th, Ac, Ra, and Pb can be loaded onto the column from a dilute acid. (Any acid concentration equal to or less than 1M is considered dilute in this invention.) Suitable carrier fluids include, but are not limited to acetate, water, lactate, citrate, saline (NaCl) and combinations thereof. Gaseous or liquid carrier fluids may be utilized. (For example, air may be used to flush the column to remove daughter isotopes.) Preferable carrier solutions may be acetate and HCl wherein the pH of the carrier solutions is greater than 2. pH is the most sensitive variable here. Any mineral acid (e.g., HCl, HNO₃, H₂SO₄) or weakly complexing matrix (such as acetate) that is less than pH 7 is suitable.

Ac, Ra, and Pb are removed using more dilute acids. Ra (but not Ac or Pb) is specifically separated using acetate at pH of 4. As long as no other parent isotopes or contaminating material are present on the immobilizing column, isotopically pure radium is generated.

This embodiment provided reproducible results for more than 4 months, wherein milkings (i.e., harvestings or elutions) from the column occurred every 2 weeks. However, milkings are not necessarily relegated to two weeks. Perhaps 10 days is a long enough equilibration period, depending on quantity of parent isotope and efficiency of the column. The equilibration period is selected so that the same content of daughter isotope is eluted as in previous cycles when a predetermined threshold of daughter isotope is reached. That predetermined threshold may be determined when a user-specified predetermined threshold of daughter isotopes is reached based on the decay rates of the parent isotope/daughter isotope pair.

The aforementioned inorganic resins were chosen given their ability to withstand 1E8 cGy of alpha dose. These resins are superior to organic resins which by contrast cannot tolerate radiation levels of 5 mCi or above.

It should be noted that while the system and method may be conducted at a myriad of temperatures, including at any temperatures near the freezing point of the carrier solutions, room temperatures (e.g., between 18° C. and 25° C.) conditions are preferable. Similarly, the invention may be conducted at a myriad of carrier fluid pressures, for example greater than 1 atmosphere, inasmuch as in some cases, positive pressure may be applied to augment natural flowrates. Otherwise, gravity flow (i.e., ambient atmosphere) is relied upon.

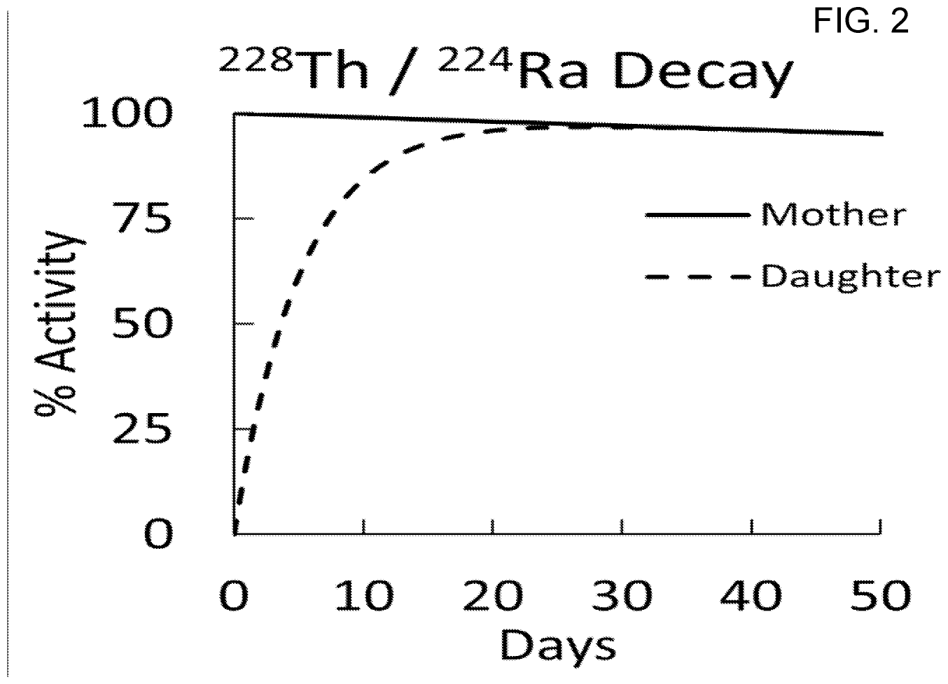

FIG. 2 is a graph comparing parent isotope radioactivity to daughter isotope radioactivity over 50 days. Specifically, FIG. 2 shows secular equilibrium decay of ²²⁸Th/²²⁴Ra which was utilized as a generator.

Parent isotope ²²⁸Th is shown slowly decreasing by less than 10 percent, while daughter isotope ²²⁴Ra is seen increasing more than 90 percent over the same time period.

In the scenario depicted in FIG. 2, once the daughter isotope reaches a certain concentration (e.g., after 25 days) the parent isotope support is “milked” or otherwise subjected to elution to remove the daughter isotope. Then the parent/daughter pair is allowed to equilibrate or otherwise recover wherein the daughter isotope concentration again approaches a 90 percent increase in concentration. Typically, harvestings occur between 1 and 50 percent saturation levels of daughter isotopes.

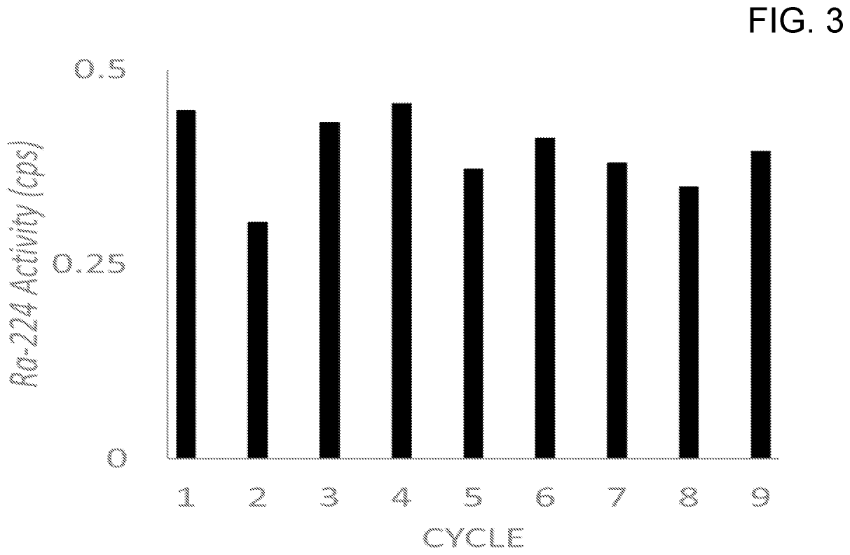

FIG. 3 shows the rebounding capability of the ²²⁴Ra in this embodiment of the invention. For example, the same content of daughter isotope is eluted as in previous cycles. Even after 8 milkings, the activity (in counts per second or cps) of the daughter isotope is more than 90 percent of the radioactivity of the daughter isotope obtained at the first milking.

Specifically, FIG. 3 depicts ²²⁴Ra elution cycles from a ²²⁸Th-loaded zirconia column. The eluents consisted of approximately 10-12 mL of 0.075M sodium acetate (pH 3.9). Each cycle spanned two week intervals which represent nearly 4 months of milking.

In an embodiment of the invention, daughter isotope is eluted from the column when the column is contacted with an acetate solution or a weakly complexing aqueous divalent radium ion matrix (such as a chloride or nitrate selected from the group consisting of RaCl₂, Ra(NO₃)₂, and combinations thereof). The inventors found that neither the solution nor the matrix disturb the immobilized parent isotope, such that the parent isotope remains on the resin, even after repeated milkings or harvestings.

In an embodiment of the invention, no cyclic chemical compounds are utilized as elution fluids. As such, no crown ether compounds are utilized to extract daughter isotopes from the column.

It should be noted that while the parent isotope is permanently affixed to the column, the isotope may need periodic maintenance to assure that it is optimally attached the column. As such, the parent isotope is eluted off, re-purified, and reattached either onto the original column or another generator for reuse. This reconditioning is called “parent breakthrough.”

### Example

An aqueous (water-based) solution is supplied, containing thorium, radium, actinium, lead, bismuth, radon, astatine, polonium, and thallium. The pH of the solution is adjusted to a range of between 3 and 7, and preferably between pH 4 and 5 and adjusted with an alkaline compound such as NaOH. For example, an acetate buffer can be used to control the pH. The resulting mixture is then applied to an inorganic resin column, such as one containing zirconia.

The column is then rinsed with a pH 3-7 solution (containing acetate) to remove radium and decay products. Thorium will remain on the stationary sorbent. To remove actinium and lead, the column is washed with pH 1-2 HCl. The column is re-rinsed with pH 3.9 acetate.

The column is allowed to equilibrate between the thorium parents and radium daughters. In the case of 228Th/224Ra, the column is allowed to equilibrate approximately two weeks before milking the column. Typically, the reactivity of the immobilized ²²⁸Th would stay the same but the ²²⁴Ra would have reached 96 percent saturation by that 2 week duration. To elute the radium, a solution of acetate pH 3.9 (volumes will depend on size of the column) may be utilized, either at ambient pressure or positive pressure to expedite elution. Again, provided that a clean feedstock is used, the eluent will contain pure radium devoid of thorium, lead, bismuth, and actinium.

The chemistry and transportability of the invented method and system allows it to field a myriad of Th/Ra pairs. For example, other Th/Ra isotope pairs suitable for leveraging with the invented method and system include, but are not limited to 227/223, 229/225, 232/228. The following wait times are required to reach 50 percent max radium activity from the fixed thorium parent:
227/223: 5 days;
228/224: 3.6 days;
229/225: 15 days; and
232/228: 5.7 years.

Solutions of lower pH can also elute mixtures of lead, actinium, and radium. To elute a mixture of these elements, a pH 1-2 solution of a mineral acid (e.g., HCl, HNO₃, H₂SO, HI, HBr and combinations thereof) is utilized until the actinium is completely drawn down. A feature of the invention is that the parent isotope (e.g., thorium) will remain fixed on the column. The HCl washes are followed with low concentrations of acetate (for example 0.01 M to 1 M acetate) at a pH ranging from between 3 and 7.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

The embodiment of the invention in which an exclusive property or privilege is claimed is defined as follows:

1. A method for generating a daughter isotope, the method comprising
a) contacting an inorganic metal oxide ion exchange column with parent isotope to create a column-parent isotope construct;
b) allowing the column to equilibrate between the parent and daughter isotopes;
c) eluting the daughter isotope from the column; and
d) repeating steps b and c.

2. The method as recited in claim 1 wherein the parent isotope is thorium, the daughter isotope is radium, and the equilibrate duration is between 2 days and 2 months.

3. The method as recited in claim 1 wherein between elution steps, the construct is subjected to processes including drying, transport, sequestration in radiation proof containers, delivery to end users of the daughter isotope, and combinations thereof.

4. The method as recited in claim 2 wherein the fluid is a liquid selected from the group consisting of sodium acetate, hydrochloric acid, water, and combinations thereof.

5. The method as recited in claim 1 wherein the parent isotope displays a radioactivity that does not decrease as a result of subsequent elutions.

6. The method as recited in claim 1 wherein the column comprises a radiation resistant material selected from the group consisting of Ti, Zr, Al, Sn, Nb, oxides devoid of P, C, and Na, and combinations thereof.

7. The method as recited in claim 1 wherein the parent isotope is ²²⁸Th and the daughter isotope is ²²⁴Ra and the equilibrate step has a duration between 5 days and 14 days.

8. The method as recited in claim 1 wherein the equilibrate step is selected so that the same content of daughter isotope is eluted when a user-specified predetermined threshold of daughter isotopes is reached based on decay rates of the parent isotope and daughter isotope.

9. The method as recited in claim 1 wherein the parent isotope is selected from an element with an atomic number greater than 88 and the daughter isotope is an element with an atomic number greater than 81.

10. The method as recited in claim 1 wherein the daughter isotope is eluted when the column is contacted with an acetate solution.

11. The method as recited in claim 1 wherein the daughter isotope is eluted when the column is contacted with a fluid having a pH between 0 and 12.

12. The method as recited in claim 1 wherein the equilibrate step has a duration to allow for daughter isotope saturation rates of between 1 percent and 50 percent.

13. A system for repeatedly generating isotopes, the system comprising;
a) a radiation-resistant sorbent column;
b) a parent isotope reversibly immobilized within the column;
c) a fluid to elute daughter isotope from the column.

14. The system as recited in claim 13 wherein the column comprises an inorganic material selected from the group consisting of Ti, Zr, Al, Sn, Nb, oxides devoid of P, C, and Na, and combinations thereof.

15. The system as recited in claim 13 wherein the parent isotope is thorium.

16. The system as recited in claim 13 wherein the fluid is a liquid having a pH above 0.

17. The system as recited in claim 13 wherein the column can be stored in a dried condition.

18. The system as recited in claim 13 wherein the column is portable so as to be transported at the site of patient use.

19. The system as recited in claim 13 wherein the parent isotope is periodically removed from the column, purified, and reinstalled on the column.

20. The system as recited in claim 13 further comprising a database of saturation levels of daughter isotope as a means to determine subsequent elution periods.
